(19) United States
(12) Patent Application Publication
(10) Pub. No.: US 2004/0151923 A1
(43) Pub. Date: Aug. 5, 2004

(54) Electrophotographic transfer sheet

(75) Inventors: Takashi Okazaki, Chiba-shi (JP); Jiro Shimizu, Chiba-shi (JP); Tomofumi Tokiyoshi, Yokohama-shi (JP); Nobuyasu Sasaguri, Chiba-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: OJI PAPER CO., LTD, Tokyo (JP)

(21) Appl. No.: 10/763,170

(22) Filed: Jan. 26, 2004

(30) Foreign Application Priority Data
Jan. 30, 2003 (JP) 2003-022564

(51) Int. Cl. B32B 15/08

(52) U.S. Cl. 428/458; 428/514

(57) ABSTRACT

There are provided electrophotographic transfer sheets comprising a substrate sheet which is a laminate comprising a thermoplastic resin film layer (A) adhesively laminated on at least one side of a core material layer (B) made of a paper substrate or a thermoplastic polyester-based resin film, and a toner receiving layer composed mainly of a conductive metal oxide coated on the surface of the thermoplastic resin film layer (A), characterised by having a Clark stiffness of at least 12 cm in the cross direction as measured according to JIS P8143.

### FIELD OF THE INVENTION

The present invention relates to an electrophotographic transfer sheet which is used in printing machines incorporating toner-based electrophotography systems. More specifically, it relates to an electrophotographic transfer sheet which produces no paper ejection jams caused by heat curling, and no transfer sheet fusion or paper breaks at the fixing heat roller, and which exhibits satisfactory printing quality and water resistance.

Prior Art

For heat-roll fixing electrophotographic printers, high quality paper sheets for plain paper copiers (PPC sheets) and polyester film surface-treated OHP sheets having surface coated with polyester film are conventionally used. However, PPC sheets are limited to uses which do not require water resistance, chemical resistance or mechanical strength, while OHP sheets exhibit good water resistance and chemical resistance, but are transparent and thus their use is limited to OHP applications. On the other hand, printing systems such as offset printing, screen printing and the like which require water resistance, chemical resistance and mechanical strength have conventionally employed a synthetic paper based on polypropylene, and the printed sheets are utilized for such purposes as documents, drawings, photographs, maps, manuals, labels, tags and the like which are carried to or pasted in environments, such as those with high humidity, exposure to chemicals, or the outdoors.

Incidentally, the heat roll surface temperature of the heat-roll fixing electrophotographic printer during toner fixing is usually from 170-200° C., which exceeds the melting point of the polypropylene used as the main raw material of a synthetic paper. Consequently, when a synthetic paper composed mainly of polypropylene (for example, “YUPO” by Yupo Corporation Inc.; Japanese Examined Patent Publication (Kokoku) No. 46-40794) is passed through a heat roll fixing electrophotographic printer, the heat causes curling thereof, and thus leads to problems such as poor passing property, printed sheet rolling, fusion of the synthetic sheet onto the fixing heat roll sections or paper tearing.

As a means of solving these problems, Japanese Unexamined Patent Publication (Kokai) No. 2002-258509 discloses an electrophotographic transfer sheet employing a laminate made of a thermoplastic film layer adhesively laminated on a core material layer comprising a paper substrate or a thermoplastic polyester resin film. This publication states that, for enhanced printing suitability and improved antistatic properties, it is preferred for at least one surface of the laminate to be conductively treated, but no concrete or detailed description is given regarding the conductive material. Moreover, while it refers to a certain range of surface electrical resistance to be achieved by the conductive treatment, even if the condition of the surface electrical resistance range described therein is satisfied, there may be many cases, depending on printing environments or printers to be used, where satisfactory image quality cannot be achieved.

Methods using conductive materials whose surface electrical resistances are not affected by a printing environment have been proposed in the prior art. Japanese Unexamined Patent Publication (Kokai) No. 2001-337478 proposes a process comprising coating the surface of a substrate made of a synthetic paper with a receiving layer containing a synthetic hectorite clay mineral as the conductive material and a polyurethane ionomer resin as the adhesive. However, synthetic hectorite clay mineral characteristically forms gels, and since gel strength is dependent on the concentration of the synthetic hectorite clay mineral, the gel strength is reduced in the presence of a high moisture content, often leading to the phenomenon of softening of the receiving layer itself. Consequently, due to the phenomenon of flaking of the receiving layer which occurs when the sheets are left in high-temperature, high-humidity environments or are immersed in water, the uses of this process have been restricted.

Use of conductive metal oxides as conductive materials whose surface electrical resistances are not affected by printing environment is also proposed. Japanese Unexamined Patent Publication (Kokai) No. 6-75419 and Japanese Unexamined Patent Publication (Kokai) No. 7-28268, for example, propose providing a layer comprising the aforementioned conductive oxides on transparent substrates, and both documents referring to surface electrical resistances which give suitable images by use of electrophotographic printers. However, they are silent with respect to use of a laminate comprising a thermoplastic film layer adhesively laminated on a core material layer made of a paper substrate or a thermoplastic polyester resin film as described above, as the substrate. Moreover, when the suitable ranges for surface electrical resistance mentioned in these publications are applied to the aforementioned laminate, depending on printing environments or printers to be used, there may be many cases where satisfactory image quality cannot be achieved.

Japanese Unexamined Patent Publication (Kokai) No. 2000-39735 proposes forming a coating layer of a polyester resin containing conductive inorganic powder on one or both sides of a raw paper sheet. Also, Japanese Unexamined Patent Publication (Kokai) No. 9-73184 proposes a process of conductive treatment of an electrophotographic transfer sheets characterized by combining a conductive metal oxide with an electrophotographic transfer material, and sets forth suitable ranges for surface electrical resistance. However, neither of these documents mention the use of a laminate comprising a thermoplastic film layer adhesively laminated on a core material layer made of a paper substrate or thermoplastic polyester resin film as described above. Moreover, when the suitable ranges for surface electrical resistance mentioned in these documents are applied to such laminates, depending on printing environments or printers to be used, there may be many cases where satisfactory image quality cannot be achieved.

On the other hand, Japanese Unexamined Patent Publication (Kokai) No. 2002-91049 discloses a sheet provided with a coating layer on the surface of an adhesively laminated sheet-like support as described above, wherein the properties for achieving satisfactory printing quality with electrophotographic printers are specified not by the surface electrical resistance but rather by the electrostatic capacity; however, many laminates having the specified electrostatic capacity (≧10 pF/cm²) are not capable of producing satisfactory printing quality by use of electrophotographic printers. As a result of detailed research, the present inventors have accomplished the present invention upon discovering that the printing quality of laminates in electrophotographic printers is highly dependent on the surface electrical resistance.

It is, therefore, an object of the present invention to provide a transfer sheet for electrophotography which produces satisfactory printing quality and water resistance, without heat curling-induced paper jamming during paper ejection, fusion of the transfer sheet onto the fixing heat roll sections or paper tearing.

### DISCLOSURE OF INVENTION

The electrophotographic transfer sheet according to the present invention can be employed in an electrophotographic system which forms images with toner particles, and comprises a substrate sheet which is a laminate comprising a thermoplastic resin film layer (A) adhesively laminated on at least one side of a core material layer (B) made of a paper substrate or a thermoplastic polyester-based resin film, and a toner receiving layer composed mainly of a conductive metal oxide coated on the surface of said thermoplastic resin film layer (A), characterised in that the Clark stiffness thereof is at least 12 cm in the cross direction as measured according to JIS P8143 (TAPPI T451). The aforementioned thermoplastic resin film layer is preferably a synthetic paper made of an oriented film composed mainly of a polyolefin-based resin and an inorganic pigment.

The conductive metal oxide is preferably made semiconductive by doping the metal oxide with an impurity. More preferably, the conductive metal oxide coats onto the surface of a base material.

The conductive metal oxide is also preferably tin oxide comprising antimony as an impurity, and the tin oxide comprising antimony as an impurity is preferably coated on the surface of a base material. The base material is most preferably acicular titanium dioxide with long axes of 1-15 μm and short axes of 0.05-0.5 μm. Also, the surface electrical resistance of the toner receiving layer composed mainly of the conductive metal oxide is preferably in the range of 1×10⁵ to 1×10¹² Ω/□.

### BEST MODE FOR CARRYING OUT THE INVENTION

Preferred modes of the present invention will now be explained in detail.

(A) Thermoplastic resin film

As examples of thermoplastic resin films for use according to the present invention, there may be mentioned polyolefin-based resins including ethylenic resins such as high-density polyethylene and medium-density polyethylene, propylene resins, polymethyl-1-pentene and ethylene-cyclic olefin copolymers, polyamide-based resins such as nylon-6 and nylon-6,6, thermoplastic polyester-based resins such as polyethylene terephthalate and its copolymers, polybutylene terephthalate and its copolymers and aliphatic polyesters, as well as polycarbonates, atactic polystyrene, syndiotactic polystyrene, and the like. Preferred among these are polyolefin-based resins.

Among the aforementioned polyolefin-based resins, propylene resins are preferred from the standpoint of chemical resistance and cost. Propylene resins include isotactic polymers and syndiotactic polymers obtained by homo-polymerization of propylene. There may also be used copolymers having various forms of tacticity, composed mainly of propylene obtained by copolymerization of propylene with α-olefins such as ethylene, 1-butene, 1-hexene or 4-methyl-1-pentene. The copolymers may be bipolymers, terpolymers, or polymers of more than three monomers, and they may be random copolymers or block copolymers. The propylene resin preferably also contains a resin having a lower melting point than the propylene homopolymer, in an amount of 2-25 wt %. Resins with such low melting points include high-density and low-density polyethylene. One type selected from among the above-mentioned thermoplastic resins may be used for the thermoplastic resin, or two or more different resins may be selected for use in combination.

If necessary, inorganic fine powders, organic fillers, stabilizers, photostabilizers, dispersing agents, lubricants and the like may be added to the thermoplastic resin. When an inorganic fine powder is added, it preferably has a particle size of 0.01-5 μm. Specifically, there may be used heavy calcium carbonate, light calcium carbonate, fired clay, silica, talc, titanium dioxide, barium sulfate, alumina or the like. When an organic filler is used, it is preferred to select a different type of resin from the major thermoplastic resin component. For example, when the thermoplastic resin is a polyolefin-based resin, the organic filler used may be a polymer such as polyethylene terephthalate, polybutylene terephthalate, polycarbonate, nylon-6, nylon-6,6, cyclic olefins, polystyrene, polymethacrylates or the like, having a melting point or glass transition temperature which is higher than the melting point of the polyolefin-based resin. When an inorganic fine powder and/or organic filler are used, they are preferably added in the range of 3-50 wt %.

When a stabilizer is added it is normally added in a range of 0.001-1 wt %. Specifically, there may be used sterically hindering phenol-based, phosphorus-based and amine-based stabilizers. When a photostabilizer is added, it is also normally added in a range of 0.001-1 wt %. Specifically, there may be used sterically hindering amine-based, benzotriazole-based and benzophenone-based photostabilizers. Dispersing agents and lubricants are used for the purpose of, for example, dispersing inorganic fine powders. They will usually be added in a range of 0.01-4 wt %. Specifically, there may be used silane coupling agents, metal soaps of higher fatty acids such as oleic acid and stearic acid, or polyacrylic acid, polymethacrylic acid and their salts.

There are no particular restrictions on the method of molding the thermoplastic resin film, and any publicly known method may be appropriately selected. Cast molding, calender molding, roll molding, inflation molding or the like may be employed, for example, using a single-layer or multilayer T-die or I-die connected to a screw-type extruder for extrusion of the molten resin into a sheet form.

The thermoplastic resin film is preferably uniaxially or biaxially oriented. The orientation may be carried out by any of the commonly employed methods. The orientation temperature may be, in the case of an amorphous resin, above the glass transition temperature of the thermoplastic resin used, and in the case of a crystalline resin, in a suitable range for the thermoplastic resin from above the glass transition temperature of the amorphous portion up to the melting point of the crystal portion. Specifically, it is preferably a temperature 2-50° C. below the melting point of the thermoplastic resin. The orientation method used may be longitudinal orientation utilizing the different circumferential speeds of a roll group, horizontal orientation utilizing a tenter oven, or simultaneous biaxial orientation using a combination of a tenter oven and a linear motor.

The orientation factor may be appropriately determined based on the properties, etc. of the thermoplastic resin used. For example, when using a propylene homopolymer or copolymer as the thermoplastic resin, the orientation factor may be 2-10 for orientation in one direction, or in the case of biaxial orientation, a factor of 10-50 in area basis is preferred.

By orientation a thermoplastic resin comprising inorganic fine powder and an organic filler, it is possible to obtain a porous resin oriented film having fine pores in its interior. The oriented thermoplastic resin film may be a single layer, or it may have a multilayer structure.

The thickness of the thermoplastic resin film is usually 15 μm or greater, and preferably 25 μm or greater. If the thickness of the thermoplastic resin film is less than 15 μm, the thickness of the resulting electrophotographic transfer sheet may be too thin, the mechanical strength may be insufficient, and it may be impossible to adequately prevent heat curling. The upper limit for the thickness of the film is not particularly restricted, but a thickness of greater than 200 μm makes the electrophotographic transfer sheet too thick, resulting in the inconvenience of decrease in the number of the sheets to be loaded in the printer sheet feeder, and is also unfavorable in terms of economy. In most cases, therefore, the thickness of the thermoplastic resin film is preferably no greater than 200 μm, and more preferably no greater than 150 μm.

(B) Core material layer

The core material layer used for the invention may preferably be a type of paper such as woodfree paper, converted paper, art paper, cast-coated paper or the like composed mainly of cellulose pulp, or a converted paper, such as a laminated sheet having a thermoplastic resin layer on at least one side. Thermoplastic polyester-based resin films such as polyethylene terephthalate and copolymers thereof, polybutylene terephthalate and copolymers thereof or aliphatic polyesters are preferably used because they are heat resistant, have smooth surfaces with low irregularities, and therefore give satisfactory printed image quality.

There are no particular restrictions on the thickness of the core material layer used for the present invention, but it will usually be from 50-200 μm. A thickness of less than 50 μm may result in insufficient mechanical strength of the obtained electrophotographic transfer sheet, resulting in inadequate repulsive force against deformation and making it impossible to satisfactorily prevent curling of the electrophotographic transfer sheet during printing. A thickness exceeding 200 μm may be too great for the electrophotographic transfer sheet, resulting in the inconveniences of decrease in the number of the sheets to be loaded in the printer sheet feeder, a reduced printing quality due to irregularities in the core material layer, and an aesthetic property of the transfer sheet.

According to the present invention, the thermoplastic resin film may be adhered to one or both sides of the core material layer. When the thermoplastic resin film is adhered to only one side of the core material layer, the side opposite to the adhered layer of the core material layer is preferably provided with a synthetic resin layer, as a coating layer, comprising a pigment, an adhesive and the like as anticurling treatment. The coating layer may be imparted with additional properties such as printability, paper feed suitability and anti-blocking properties, while it may also, of course, be imparted with water resistance, oil resistance, sliding resistance, and suitability for various types of recording such as thermosensitive recording, heat transfer recording or inkjet recording.

When the thermoplastic resin film is adhered onto both sides of the core material layer, the laminated thermoplastic resin film may be the same film as on the back side or a different type from the back side film, and when a polypropylene resin film is laminated on one side of the base material layer, it is preferred for a polypropylene resin film to also be laminated on the other side from the standpoint of both plain sheet curling and printed sheet curling.

There are no particular restrictions on the method of adhesively laminating the thermoplastic resin film layer (A) on at least one side of the core material layer (B), and publicly known techniques such as wet lamination, extrusion lamination, dry lamination, wax lamination or the like may be employed. Dry lamination is a widely used process, and the adhesives used therefor are often mixtures of polymer adhesive components such as polyethers, polyesters or the like in admixture with curing agents such as polyisocyanates or epoxy compounds. The adhesive coating weight is preferably in the range of 1-30 g/m². When the thermoplastic resin film layer (A) is adhesively laminated on both sides of the core material layer (B), the coating weight is preferably the same for the adhesive on the front side film layer and the back side film layer, in order to maintain a satisfactory curl balance. Extrusion lamination is preferably used for achieving higher printing quality.

(C) Toner receiving layer

The present invention is characterized in that fine particles of a metal oxide made semiconductive by doping the metal oxide with an impurity are used as the conductive material of a valence electron controlled semiconductor exhibiting p-type semiconductivity or n-type semiconductivity, to provide a toner receiving layer on the thermoplastic film layer (A) of a laminate support as described above, together with the adhesive, etc., wherein the toner receiving layer forms a conductive path by contact between the fine particles. As a conducting effect is exhibited through the formed conductive path, it is possible to achieve a constant, stable conductive property which is not dependent on humidity. Thus, by conductive treatment with fine particles of a conductive metal oxide for enhancement of the environmental characteristics of the surface electrical resistance, a toner receiving layer was developed which has a constant surface electrical resistance range against a wide extent of environmental variation from low humidity to high humidity, and which exhibits satisfactory toner transfer properties regardless of the printing environment, or more specifically, a toner receiving layer which produces satisfactory prints in electrophotographic printers regardless of the printing environment. Furthermore, as the conductive metal oxide does not form a gel that softens when exposed to abundant water, as occurs with the synthetic hectorite compound used as the conductive material in Japanese Unexamined Patent Publication (Kokai) No. 2001-337478, there is no loss of water resistance.

Most metal oxides become semiconductive when their constitutions deviate from the chemically-equivalent constitution through reduction or oxidation, but it is difficult to control such deviation, and the necessary conductivity (σ) cannot be easily adjusted. Consequently, by doping a metal ion with an atomic valence differing by only ±1 as an impurity in place of the constituent metal ion of the metal oxide, it is possible to improve the conductivity control and stability to yield a suitable valence electron controlled semiconductor. As metal oxides which exhibit improved conductivity by reduction, there may be mentioned ZnO, TiO₂, SnO₂, Ta₂O₅, ThO₂ and PbCrO₄, and as metal oxides which exhibit improved conductivity by oxidation, there may be mentioned NiO, FeO, MnO, CoO, Cu₂O, Cr₂O₃, MoO₂ and Bi₂O₃. A “conductive metal oxide” may also be obtained by doping with a metal ion having an atomic valence differing by only ±1 from the constituent metal ion, as an impurity to ensure controllability and stability.

As conductive metal oxides used as conductive materials for the present invention there may be mentioned SnO₂(Sb) (SnO₂ doped with Sb; similar notation hereunder), TiO₂(Sb), ZnO(Al), ZnO(Ga), SnO₂(F), NiO(Li) and In₂O₃(Sn). For adjustment in the required range of surface electrical resistance, it is preferred to use a conductive metal oxide doped with antimony (Sb) as the impurity, but since the improvement in conductivity due to the impurity content is also accompanied by an increase in haze value, while antimony Sb causes a bluish gray color change, and thus colors the toner receiving layer, this problem may be solved or ameliorated by preferably using a composite conductive material having the conductive metal oxide coated onto the surface of a common (non-conductive) base material.

For example, a Sb-doped tin oxide (SnO₂(Sb)) conductive layer coated onto the surface of acicular rutile titanium dioxide (TiO₂), as conductive titanium dioxide (SnO₂(Sb)/TiO₂), is commercially available as the TIPAQUE FT and ET Series by Ishihara Sangyo Co., Ltd.; Sb-doped tin oxide (SnO₂(Sb)) simple substance is commercially available as the TIPAQUE SN and FS Series by Ishihara Sangyo Co., Ltd.; a tin oxide (SnO₂)·antimony oxide (Sb₂O₅) thin-layer coated onto the surfaces of potassium titanate (K₂O·nTiO₂) whiskers, as conductive potassium titanate (SnO₂·Sb₂O₅/K₂O·nTiO₂) whiskers, are commercially available as the DENTALL WK Series by Otsuka Chemical Co., Ltd.; and a Sb-doped tin oxide (SnO₂(Sb)) conductive layer coated onto the surface of barium sulfate plate (BaSO₄), as conductive barium sulfate (SnO₂(Sb)/BaSO₄), and a Sb-doped tin oxide (SnO₂(Sb)) conductive layer coated onto the surface of aluminum borate (9Al₂O₃·2B₂O₃) whiskers, as conductive barium sulfate (SnO₂(Sb)/9Al₂O₃·2B₂O₃) whiskers, are commercially available as PASSTRAN Series Type-IV and -V by Mitsui Kinzoku Kogyo Co., Ltd. These single material or composite material may be used, as appropriate, either alone or in combination in consideration of setting the range of variation for the surface electrical resistance and the degree of whiteness, as one of the aspects of appearance.

In order to give satisfactory conductivity to an insulator, it is usually essential for the included conductive material to effectively express its conductivity. For conductivity to be effectively exhibited, it is necessary to form a conductive path by causing effective contact between the powder particles in the toner receiving layer formed on the thermoplastic film layer (A). The contacts between the conductive metal oxide particles are largely governed by the state of dispersion and orientation of the included powder. An optimum conductive state requires a lack of cohesion between powder particles but a high rate of contact between powder particles.

It matters of specific importance to the shape of the conductive metal oxide itself or the shape of the carrier coating the conductive metal oxide. With more spherical shapes, the particles tend to disperse less easily and aggregate more readily. The filling ratio in the insulator is the major issue for increasing the rate of contact for a spherical conductive agent, and this necessarily requires a large amount of conductive material to be included. Therefore, employing a spherical conductive agent raises the need for special dispersing tools and equipment. Also, finer sizes tend to accentuate the tendency described above. As a result, as employing spherical conductive materials has been highly expensive, their uses have been limited.

The present inventors carried out diligent research in light of the above situation and consequently discovered that by using an appropriate acicular oxide as the base material and coating its surface with a conductive metal oxide according to the invention, wherein the base material preferably has long axes of 1-15 μm and short axes of 0.05-0.5 μm, it is possible to effectively decrease the surface electrical resistance of the toner receiving layer. More preferably, by using acicular titanium oxide as the base material and coating its surface with tin oxide comprising antimony as the impurity (SnO₂(Sb)/TiO₂), wherein the base material has long axes of 1-15 μm and short axes of 0.05-0.5 μm, it was possible to vastly increase the rate of contact between the conductive metal oxide particles based on their shapes, and thereby effectively decrease the surface electrical resistance of the toner receiving layer.

When the aforementioned conductive metal oxide is used to control the surface electrical resistance, the surface electrical resistance will generally depend on the coating weight of the conductive metal oxide. That is, a low coating weight will prevent formation of conductive paths, leading to a high surface electrical resistance value. As the coating weight gradually increases, the resulting formation of conductive paths leads to a decrease of the surface electrical resistance, but control of the surface electrical resistance will be easier, if the decrease of surface electrical resistance with respect to the increase in coating weight is relatively moderate. As a result of diligent research by the present inventors, it was found that by incorporating at least one other pigment in the conductive metal oxide coating, it is possible to inhibit formation of conductive paths, and thus produce a moderate decrease of surface electrical resistance with respect to the increase in coating coverage, thereby resulting in easier control of the surface electrical resistance.

There are no particular restrictions on such additional pigments to be incorporated, and for example, there may be used heavy calcium carbonate, light calcium carbonate, fired clay, silica, talc, titanium dioxide, barium sulfate, alumina or the like. A conductive metal oxide differing from the conductive metal oxide of the present invention used to decrease the surface electrical resistance may also be used as an additionally included pigment.

There are no particular restrictions on the method of forming the toner receiving layer of the electrophotographic transfer sheet according to the present invention and, for example, it may be formed by a method of coating and drying a coated layer by air knife coating, wire bar coating, blade coating, roll coating, gravure coating, reverse roll coating, curtain coating, die slot coating, champlex coating, brush coating, lip coating, slide bead coating, two-roll or metering blade-type size press coating, bill blade coating, gate roll coating or the like.

There are also no particular restrictions on the coating weight of the coating color, and it may ordinary be varied within a range of about 0.1 to 10 g/m², and preferably 0.1 to 5 g/m², on dry weight basis per side. A coating weight of less than 0.1 g/m² may increase the surface electrical resistance and result in inferior toner transfer properties. On the other hand, a coating weight of greater than 10 g/m² will result in increased cost. Depending on the purpose of use, the coating and drying steps may be followed by smoothing treatment with a super calender, machine calender, soft calender or the like.

By appropriately selecting and setting the type of conductive metal oxide, the shape of the conductive metal oxide itself or the shape of the carrier coating the conductive metal oxide, the coating weight, the type of additional pigment to be incorporated and the coating method in the manner described above, it is possible for a person skilled in the art to control the surface electrical resistance of the toner receiving layer as desired. The surface electrical resistance of the toner receiving layer is preferably in the range of 1×10⁵ to 1×10¹² Ω/□, more preferably 3×10⁵ to 1×10¹¹ Ω/□, and even more preferably 1×10⁶ to 1×10⁹ Ω/□.

The toner receiving layer may have a multilayer structure provided with one or, if necessary, two or more intermediate layers. In the case of a multilayer structure, the respective coating color do not need to be the same or be coated to the same degree of coating weight, and there are no particular restrictions so long as appropriate control is carried out according to the desired level of quality. When the toner receiving layer is provided on one side of the substrate, the other side may be provided with a synthetic resin layer, a coating layer or an antistatic layer comprising a pigment and adhesive, to impart curl resistance, printing suitability, paper feed suitability, anti-blocking properties and so on. The other side of the support may also, of course, be subjected to various types of treatment to provide, for example, adhesiveness, magnetism, flame retardance, heat resistance, water resistance, oil resistance or sliding resistance, and suitability for various types of recording such as thermosensitive recording, heat transfer recording or inkjet recording, for various purposes of use.

The electrophotographic transfer sheet obtained according to the present invention has a Clark stiffness of at least 12 cm, and preferably at least 15 cm in the cross direction as measured according to JIS P8143 (TAPPI T451) under ISO environment while controlling the humidity whole day and night (23° C.-50% RH). If the Clark stiffness is less than 12 cm, paper passing problems may occur in heat roll fixing-type electrophotographic printers.

### EXAMPLES

The present invention will now be explained in greater detail through the following examples, with the understanding that these examples are not limitative on the scope of the invention. The “parts” and “%” values in the examples refer to “parts by weight” and “percentage by weight”, unless otherwise specified.

### Example 1

[Formation of Toner Receiving Layer]

Conductive metal oxide 100 pts. by wt.

(product name: FT2000, SnO₂(Sb)-coated acicular titanium dioxide, Ishihara Sangyo Co., Ltd.)

Polyurethane ionomer 100 pts. by wt. (product name: HYDRAN AP40, Dichercules Chemicals Inc.)

Dispersing agent 1 pt. by wt.

(product name: ALON A-9, To a Gosei Inc.)

The composition (20% concentration, aqueous) was mixed and stirred, and the resulting coating color was coated onto one side of a synthetic paper (product name: YUPO FPG80, Yupo Corporation Inc.) to a dry coating weight of 3 g/m² using a bar coater, and then dried to obtain a toner receiving sheet.

The both sides of a 100 μm-thickness art paper (Oji Paper Co., Ltd., Kinfuji™, 104.7 g/m²) were laminated with the aforementioned toner receiving sheet by dry lamination, to fabricate an electrophotographic transfer sheet.

### Example 2

[Formation of Toner Receiving Layer]

Conductive metal oxide 100 pts. by wt.

(product name: SN-100P, Sb-doped spherical tin oxide, Ishihara Sangyo Co., Ltd.)

Polyester resin 100 pts. by wt.

(product name: PESRESIN S-110G, Takamatsu Yushi Co., Ltd.)

The composition (20% concentration, toluene/MEK) was mixed and stirred, and the resulting coating mixture was coated onto one side of a synthetic paper (product name: YUPO FPG80, Yupo Corporation Inc.) to a dry coating weight of 3 g/m² using a bar coater, and then dried to obtain a toner receiving sheet.

The both sides of a 100 μm-thickness art paper (Oji Paper Co., Ltd., Kinfuji™, 104.7 g/m²) were laminated with the aforementioned toner receiving sheet by dry lamination, to fabricate an electrophotographic transfer sheet.

### Example 3

The same toner receiving sheet as in Example 1 was laminated onto the both sides of a 70 μm-thickness coated paper (Oji Paper Co., Ltd., OK TOPCOAT™, 84.9 g/m²) by dry lamination to fabricate an electrophotographic transfer sheet.

### Example 4

An electrophotographic transfer sheet was fabricated in the same manner as Example 1, except that the toner receiving layer coating weight was 1 g/m².

### Comparative Example 1

[Formation of Toner Receiving Layer]

Synthetic hectorite clay mineral 100 pts. by wt.

(product name: LAPONITE RD, Laporte Industries Inc.)

Polyurethane ionomer 100 pts. by wt.

(product name: HYDRAN AP40, Dichercules Chemicals Inc.)

Dispersing agent 1 pt. by wt.

(product name: ALON A-9, To a Gosei Inc.)

The composition (20% concentration, aqueous) was mixed and stirred, and the resulting coating mixture was coated onto one side of a synthetic paper (product name: YUPO FPG80, Yupo Corporation Inc.) to a dry coating weight of 3 g/m² using a bar coater, and then dried to obtain a toner receiving sheet.

The both sides of a 100 μm-thickness art paper (Oji Paper Co., Ltd., Kinfuji™, 104.7 g/m²) were laminated with the aforementioned toner receiving sheet by dry lamination, to fabricate an electrophotographic transfer sheet.

### Comparative Example 2

The same toner receiving layer as in Example 1 was coated onto both sides of a sheet to a dry coating weight of 3 g/m² on each side, and then dried to obtain a toner receiving sheet which was used as an electrophotographic transfer sheet without lamination on the other substrate.

[Measurement of Stiffness of Transfer Sheets for Electrophotography]

The obtained transfer sheets for electrophotography were measured for Clark stiffness according to JIS P8143 under ISO environment while controlling the humidity whole day and night (23° C.-50% RH). The results are shown in Table 1.

[Measurement of Surface Electrical Resistance of Transfer Sheets for Electrophotography]

The obtained electrophotographic transfer sheets were stored for 10 hours under the low humidity conditions, normal humidity conditions and high humidity conditions described below, and then the surface electrical resistance was measured using an R12704 electrical resistance meter (Advantest Inc.). The low humidity conditions, normal humidity conditions and high humidity conditions were as follows. The results are shown in Table 2.

Low humidity conditions, normal humidity conditions and high humidity conditions:

Low humidity: 10° C., 30% RH

Normal humidity: 20° C., 65% RH

High humidity: 30° C., 85% RH

[Evaluation of Recording Suitability of transfer Sheets for Electrophotography]

The obtained electrophotographic transfer sheets were stored for 10 hours under low humidity conditions, normal humidity conditions and high humidity conditions, and then used for image recording using an LBP2040N color copier (Canon Inc.) in each environment, after which the image quality was visually evaluated based on the scale shown below. The results are shown in Table 3.

The low humidity conditions, normal humidity conditions and high humidity conditions were the same as for the surface electrical resistance measurement described above.

⊚: Satisfactory toner transfer property and high image density. very satisfactory quality.

◯: Satisfactory toner transfer property and adequately high image density. Superior quality with no problem for practical use.

Δ: Slightly uneven toner transfer property, poor image density. Problem for practical use.

x: Considerably uneven toner transfer property, very poor image density. Problem for practical use.

[Evaluation of Passing Property of Transfer Sheets for Electrophotography]

The obtained electrophotographic transfer sheets were used for image recording using an LBP2040N color copier (Canon Inc.), and the number of paper passing problems while printing a set of 100 sheets was confirmed. The results are shown in Table 4.

The low humidity conditions, normal humidity conditions and high humidity conditions were the same as for the surface electrical resistance measurement described above.

⊚: Number of problems: 0

◯: Number of problems: ≦2, no problem for practical use

Δ: Number of problems: ≦5, a problem for practical use

x: Number of problems: ≧10, a problem for practical use

[Evaluation of Toner Peeling by Water-Immersion of Printed Sections]

The obtained electrophotographic transfer sheets were stored for 10 hours under normal humidity conditions, and then used for image recording using an LBP2040N color copier (Canon Inc.). The printed samples were immersed in water for one minute each and removed, and the printed sections were rubbed with a finger. The degree of toner peeling was visually evaluated based on the following scale. The results are shown in Table 4.

⊚: No toner peeling

◯: Slight toner peeling, but no problem for practical use.

Δ: Some toner peeling, with problem for practical use.

x: Notable toner peeling, with problem for practical use.

TABLE 1

| | Clark stiffness (cm) |
|---|---|
| Example 1 | 24.0 |
| Example 2 | 24.2 |
| Example 3 | 20.0 |
| Example 4 | 24.0 |
| Comp. Ex. 1 | 24.2 |
| Comp. Ex. 2 | 10.0 |

TABLE 2

| | Surface electrical resistance [Ω] | | |
|---|---|---|---|
| Environment | 10° C./30% RH | 20° C./65% RH | 30° C./85% RH |
| Example 1 | 8.0 × 10⁶ | 5.0 × 10⁶ | 8.7 × 10⁶ |
| Example 2 | 1.2 × 10⁸ | 2.3 × 10⁸ | 7.0 × 10⁷ |
| Example 3 | 8.0 × 10⁶ | 4.8 × 10⁶ | 7.0 × 10⁶ |
| Example 4 | 5.0 × 10¹⁰ | 1.0 × 10¹⁰ | 8.0 × 10⁹ |
| Comp. Ex. 1 | 9.0 × 10⁸ | 2.0 × 10⁸ | 7.7 × 10⁷ |
| Comp. Ex. 2 | 8.8 × 10⁶ | 5.1 × 10⁶ | 9.0 × 10⁶ |

TABLE 3

| | Image quality | | |
|---|---|---|---|
| Environment | 10° C./30% RH | 20° C./65% RH | 30° C./85% RH |
| Example 1 | ⊚ | ⊚ | ⊚ |
| Example 2 | ⊚ | ⊚ | ⊚ |
| Example 3 | ⊚ | ⊚ | ⊚ |
| Example 4 | ∘ | ∘ | ∘ |
| Comp. Ex. 1 | ⊚ | ⊚ | ⊚ |
| Comp. Ex. 2 | Unprintable | Unprintable | Unprintable |
| | (paper | (paper | (paper |
| | jamming) | jamming) | jamming) |

TABLE 4

| | Toner peeling evaluation | |
|---|---|---|
| | (water resistance) | Passing property |
| Example 1 | ⊚ | ⊚ |
| Example 2 | ⊚ | ⊚ |
| Example 3 | ⊚ | ⊚ |
| Example 4 | ⊚ | ⊚ |
| Comp. Ex. 1 | x | ⊚ |
| Comp. Ex. 2 | Unprintable | x |
| | (paper jamming) | |

As clearly seen from Examples 1 to 4, the electrophotographic transfer sheets according to the present invention had stable surface electrical resistance values in a wide range of environments from low temperature, low humidity to high temperature, high humidity, exhibited excellent toner transfer properties and produced high image density and high quality images. In addition, the electrophotographic transfer sheets occurred no paper jamming during ejection due to heat curling and underwent no fusion of the transfer sheets or paper breaks at the fixing heat roller, while also preventing water-immersed paper tears or distortions and toner peeling, and are therefore of high practical utility.

It will be appreciated by those skilled in the art that while the invention has been described above in connection with particular embodiments and examples, the invention is not necessarily so limited and that numerous other embodiments, examples, uses, modifications and departures from the embodiments, examples and use may be made without departing from the inventive scope of this application.

What is claimed is:

1. An electrophotographic transfer sheet comprising a substrate sheet which is a laminate comprising a thermoplastic resin film layer (A) adhesively laminated on at least one side of a core material layer (B) made of a paper substrate or a thermoplastic polyester-based resin film, and a toner receiving layer composed mainly of a conductive metal oxide coated on the surface of said thermoplastic resin film layer (A), characterised by having a Clark stiffness of at least 12 cm in the cross direction as measured according to JIS P8143.

2. The electrophotographic transfer sheet according to claim 1, wherein said thermoplastic resin film is a synthetic paper comprising on oriented film composed mainly of a polyolefin-based resin and an inorganic pigment.

3. The electrophotographic transfer sheet according to claim 1, wherein said conductive metal oxide is made semiconductive by doping the metal oxide with an impurity.

4. The electrophotographic transfer sheet according to claim 3, wherein said conductive metal oxide coats onto the surface of a base material.

5. The electrophotographic transfer sheet according to claim 1, wherein said conductive metal oxide is tin oxide comprising antimony as an impurity.

6. The electrophotographic transfer sheet according to claim 5, wherein said conductive metal oxide comprises said tin oxide coated on a base material surface.

7. The electrophotographic transfer sheet according to claim 4, wherein said base material is acicular titanium dioxide with long axes of 1-15 μm and short axes of 0.05-0.5 μm.

8. The electrophotographic transfer sheet according to claim 1, wherein said toner receiving layer further comprises at least one type of pigment.

9. The electrophotographic transfer sheet according to claim 1, wherein the surface electrical resistance of said toner receiving layer is 1×10⁵ to 1×10¹² Ω/□.
